(19) United States
(12) Patent Application Publication
(10) Pub. No.: US 2008/0239553 A1
(43) Pub. Date: Oct. 2, 2008

(54) STORAGE APPARATUS AND HEAD POSITION DEMODULATING APPARATUS

(75) Inventors: Nobuyuki Myouga, Kawasaki (JP); Yoshinari Higashino, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/053,001

(22) Filed: Mar. 21, 2008

(30) Foreign Application Priority Data
Apr. 2, 2007 (JP) 2007-96503

(51) Int. Cl. G11B 5/58

(52) U.S. Cl. 360/77.01

(57) ABSTRACT

A servo pattern demodulating system for a storage apparatus includes a processing unit which calculates an outer product and an inner product of first and second vector information items read from a servo pattern recorded on a recording medium. The processing unit calculates a tangent value of an angular difference by a division between a value of the outer product and a value of the inner product, and converts a tangent value into track position information in conformity with an approximate formula and a difference table. In the difference table, each difference between the track position information corresponding to a tangent value and a value of the approximate formula is stored. The processing unit adds up the track position information based on the approximate formula and the difference, thereby to demodulate the position offset magnitude of the head.

### BACKGROUND

1. Field

The present technique relates to a head position demodulating apparatus and a storage apparatus in which a servo pattern read from a storage medium by a head is demodulated so as to detect the position of the head, and more particularly to a head position demodulating apparatus and a storage apparatus for demodulating the position of a head at a high resolution.

2. Description of Related Art

A disk apparatus in which a storage medium is made of a rotary member has been extensively utilized as a storage apparatus which is connected to a host. In the disk apparatus, a head is located at the track of the disk, and it reads/writes data on the track. Therefore, the position of the head on the disk needs to be detected.

In a magnetic disk apparatus, for example, a magnetic disk is circumferentially formed with a large number of tracks from the outer periphery of the magnetic disk over to the inner periphery thereof, and servo signals (position signals) are arranged at equal intervals in the circumferential direction of the magnetic disk on each track. Each track is formed of a plurality of sectors, and the servo signals are recorded in the individual sectors.

Each of the servo (position) signals consists of a servo mark SMK, a Gray Code, a Position Burst signal and a Post Code.

The servo mark indicates the head of the servo signal, and it causes the apparatus to recognize that the signals subsequent to this servo mark constitute the servo signal. The gray code indicates a cylinder number. The post code indicates the eccentricity correction magnitude of the corresponding servo sector. The position burst signal is used for detecting the track position of the head and the position thereof within the track.

FIG. 1 is a diagram for explaining a phase servo pattern signal CB for head position demodulation in the related art. As shown in FIG. 1, a phase region is of three phases “even1”, “odd1” and “even2”, and each phase is in a pattern having a predetermined feed angle per track. More specifically, the pattern EVEN1 has a feed angle (per track) of +90 degrees, the pattern ODD1 has a feed angle of −90 degrees, and the pattern EVEN2 has a feed angle of +90 degrees.

By way of example, in the phase pattern (sinusoidal waves) EVEN1, the phase difference between a certain track “Tr0” and a track “Tr1” adjacent thereto is +90 degrees. Likewise, in the phase pattern ODD1, the phase difference between the certain track Tr0 and the adjacent track Tr1 is −90 degrees. Accordingly, all the phase patterns EVEN1, EVEN2 and ODD1 are patterns in each of which repetitions continue in units of 4 tracks (cylinders).

On the basis of the phase patterns, ±2-cylinder demodulation can be performed by the calculations of Formulas (1) and (2) given below. Such a phase demodulation method is disclosed in, for example, Japanese Patent No. 3,340,077, Japanese Laid-open Patent Publication No. 10-83640, and Japanese Laid-open Patent Publication No. 11-144218.

### [Formula 1]

(±1 Cyl demodulation)=(EVEN 1+EVEN2)/2−ODD1 (1)

### [Formula 2]

(±2 Cyl demodulation)=(±1 Cyl demodulation)/2 (2)

More specifically, as shown in FIGS. 2 and 3, the phase difference “Pos” is changed from 0 degree to 360 degrees by the calculation of Formula (1), and the tracks (cylinders) can be demodulated in 90-degree units.

Further, regarding positions within each track (cylinder), the positions can be demodulated within the track “0” for the phase difference Pos of 0 degree through 89 degrees, they can be demodulated within the track “1” for the phase difference Pos of 90 degrees through 179 degrees, they can be demodulated within the track “3” for the phase difference Pos of 180 degrees through 269 degrees, and they can be demodulated within the track “4” for the phase difference Pos of 270 degrees through 359 degrees.

The two phase servo information items (EVEN1, EVEN2 and ODD1) of a medium as read by a head are demodulated into two rotating vector information items by a read channel. As shown in FIG. 4, the two rotating vector information items A and B correspond to the phase patterns EVEN1 and EVEN2 and to the phase pattern ODD1, respectively. Accordingly, the angular difference θ between the vector A (e1+e2) and the vector B(o1) is computed. A position offset magnitude in the radial direction of the medium is computed from the angular difference (phase difference).

The angular difference between the vectors cannot be directly computed from the vectors. Therefore, a gradient tan(θ) is computed by the division between the inner product and outer product of the vector information items.

More specifically, as shown in FIG. 5, the outer product is represented by Formula (3) given below, while the inner product is represented by Formula (4) given below.

### [Formula 3]

A×B=|A||B|sin θ outer product (3)

### [Formula 4]

A·B=|A||B|cos θ inner product (4)

Accordingly, the gradient tan(θ) can be computed by Formula 5 given below.

### [Formula 5]

$$tan θ = \frac{\vert A \vert \vert B \vert sin θ}{\vert A \vert \vert B \vert cos θ} = \frac{A \times {B}^{( outer product )}}{A \cdot {B}^{( inner product )}} \qquad ( 5 )$$

When the position offset magnitude within the track is to be computed from the value tan(θ) thus computed, the phase difference θ is evaluated in such a way that, as shown in FIG. 5, the computed value tan(θ) is subjected to an arc tangent (ATAN) calculation. Subsequently, the phase difference θ is converted into the track position. In this way, the phase servo information has been demodulated, and the position offset magnitude within the track has been computed.

A low price and a position control of high precision have been required of apparatuses in recent years. The position demodulation calculation as stated above needs to be executed in each sample. A high-speed and expensive processor or a dedicated processor is necessitated in order to process the tan(θ) and ATAN calculations, and this forms a factor for sharply increasing the prices of the apparatus. Especially in a magnetic disk apparatus of small size and low price, it is difficult to realize the high-precision position control.

It is also considered to omit the ATAN calculation by employing a table in which values tan (θ) and θ are associated, for such conversion into the track position. The variable ATAN, however, has a nonlinear characteristic. Therefore, in a case, for example, where a position demodulation of high precision as attains a resolution of 4096 steps within a range of 0.25 track is necessary, a table size and a memory size for storing the nonlinear data enlarge, and this forms a factor for sharply increasing the price of the apparatus.

Especially in a magnetic disk apparatus of small size, low price and large capacity, it is difficult to realize the conversion. In recent years, with a demand for the enlargement of a capacity, a track pitch has narrowed, and a high resolution has been required of the position demodulation.

Accordingly, an object of the present technique is to provide a storage apparatus and a head position demodulating apparatus which can inexpensively realize a configuration for demodulating a phase servo signal at a high precision.

Besides, another object of the technique is to provide a storage apparatus and a head position demodulating apparatus which can realize the demodulation of a phase servo signal at a high resolution and which can be realized by inexpensive configurations.

Further, another object of the technique is to provide a storage apparatus and a head position demodulating apparatus which can sharply reduce a table size for demodulating a phase servo signal and which can realize the apparatuses of high precision at a low price.

### SUMMARY

This disclosed technique was produced for solving the problems due to the foregoing related techniques. In keeping with one aspect of the technique, a storage apparatus includes, at least, a head for reading data of a plurality of tracks arranged on a storage medium, in which a servo pattern read by the head is demodulated so as to detect a position of the head. The servo pattern includes: a phase servo pattern region in which a plurality of phase patterns having phases differing between respectively adjacent ones of the plurality of tracks have phases opposite to each other. The storage apparatus further includes a servo demodulation circuit which demodulates first vector information of a first phase pattern of the plurality of phase patterns and second vector information of a second phase pattern opposite in phase to the first phase pattern, from a signal of the phase servo pattern region as reproduced by the head; and a control unit which detects a position offset magnitude of the head from a center of the track, on the basis of an angular difference between the first vector information and the second vector information, and which drives an actuator for a head in accordance with the detected position offset magnitude, so as to locate the head on the center of the target track. The control unit includes a processing unit which calculates an outer product and an inner product of the first and second vector information items, which calculates a tangent value of the angular difference by a division between a value of the outer product and a value of the inner product, and which converts the tangent value into track position information in conformity with an approximate formula, and a difference table in which each difference between the track position information corresponding to the tangent value and a value of the approximate formula is stored. The processing unit adds up the track position information based on the approximate formula and the difference, thereby to demodulate the position offset magnitude.

### BRIEF DESCRIPTION OF THE DRAWINGS

FIG. 1 is a diagram for explaining a phase servo pattern;

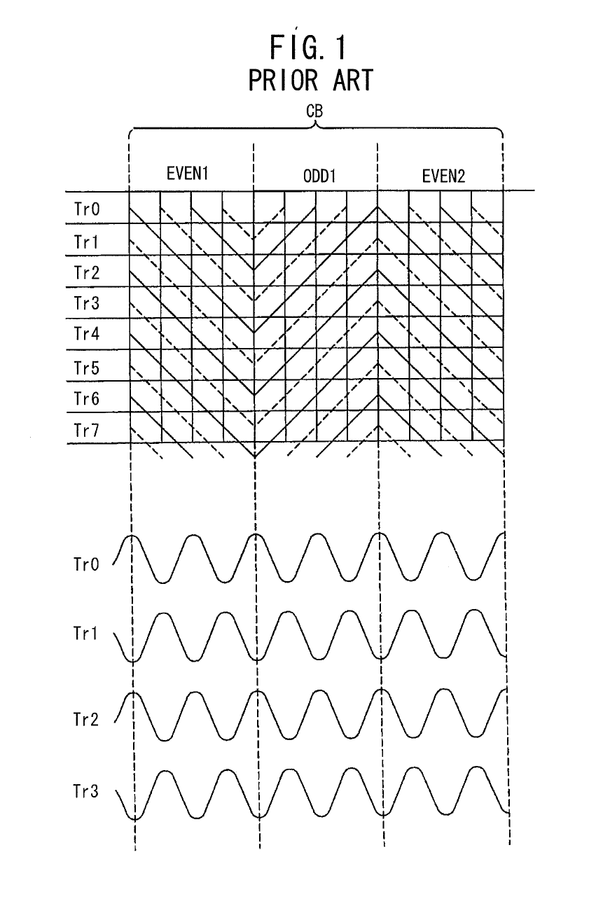

FIG. 2 is a diagram for explaining a track position demodulating operation based on the angular difference of the phase servo pattern;

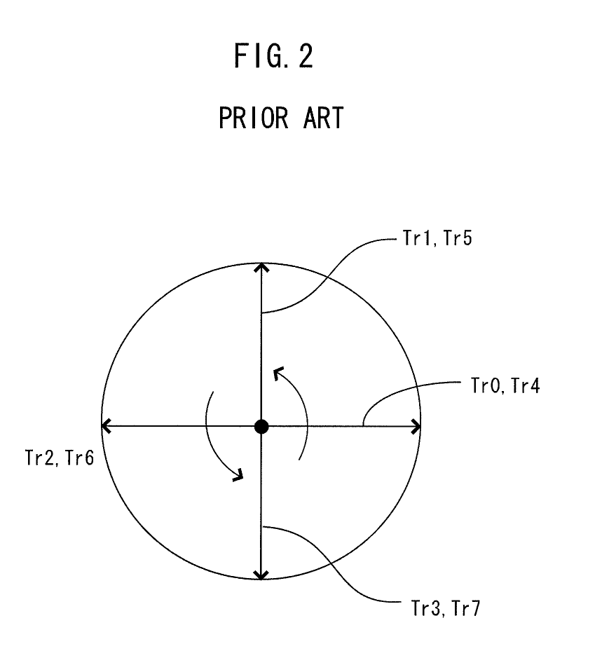

FIG. 3 is a diagram showing the relations between the angle of the phase servo pattern and ±2-cylinder demodulation;

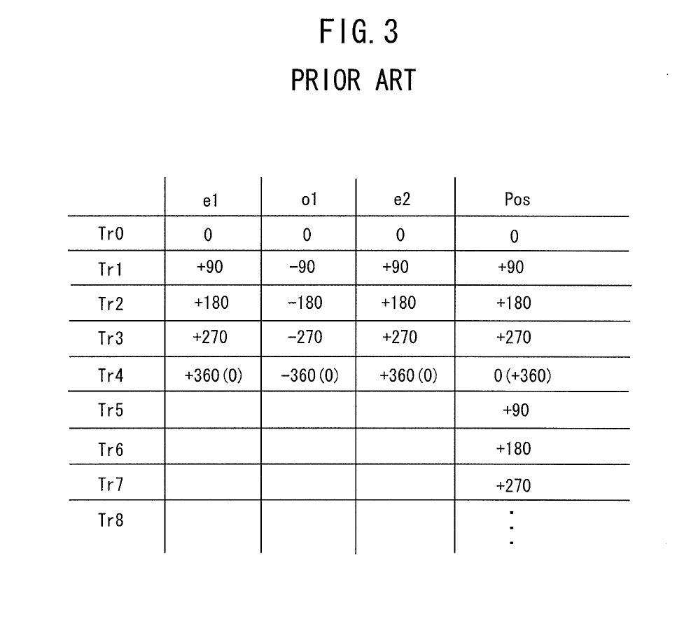

FIG. 4 is a diagram for explaining a process for computing the tangent value of the angular difference of the phase servo pattern;

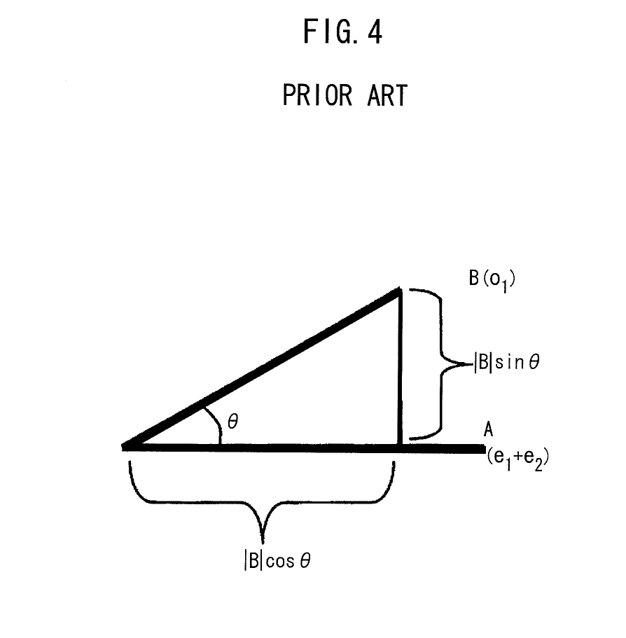

FIG. 5 is a diagram for explaining the tangent value of the angular difference of the phase servo pattern and a track position offset magnitude;

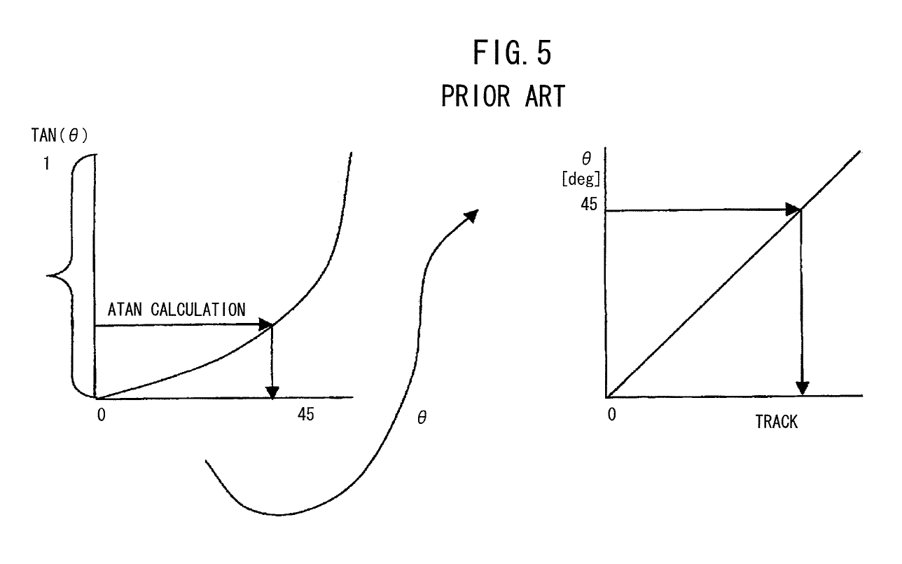

FIG. 6 is a configurational diagram showing a storage apparatus in an embodiment;

FIG. 7 is a diagram for explaining the phase servo pattern of a storage medium in FIG. 6;

FIG. 8 is a configurational diagram showing a position demodulating channel in FIG. 6;

FIG. 9 is a diagram for explaining a process for computing the tangent value of an angular difference in FIG. 8;

FIG. 10 is a diagram for explaining the tangent value computed in FIG. 9 and a track position offset magnitude;

FIG. 11 is a diagram for explaining another process for computing the tangent value of an angular difference in FIG. 8;

FIG. 12 is a diagram for explaining the tangent value computed in FIG. 11 and a track position offset magnitude;

FIG. 13 is a diagram showing the relationship between the computation process in FIG. 9 and the computation process in FIG. 11;

FIG. 14 is a format diagram of a difference table in FIG. 8;

FIG. 15 is a diagram for explaining a process for computing an approximate formula in FIG. 8; and

FIG. 16 is a diagram for explaining the difference table in FIG. 8.

### DETAILED DESCRIPTION OF THE EMBODIMENTS

### 1. First Embodiment

Now, embodiments of the present technique will be described in the order of a storage apparatus, a head position demodulating apparatus, and another embodiment, but the technique shall not be limited to the embodiments.

(Storage Apparatus)

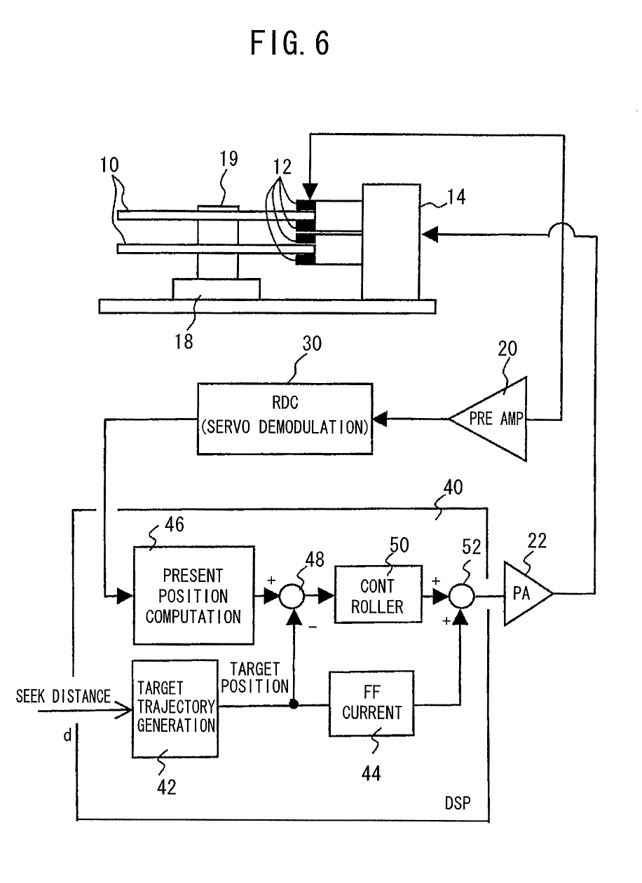

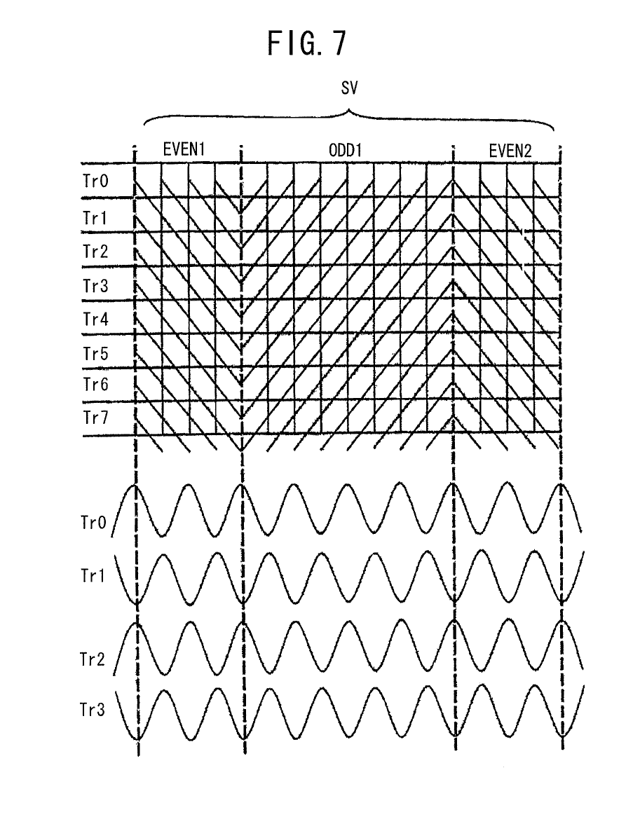

FIG. 6 is a configurational diagram showing a storage apparatus in one embodiment, while FIG. 7 is a diagram for explaining phase servo information in FIG. 6. FIG. 6 shows a magnetic disk apparatus as the storage apparatus.

As shown in FIG. 6, magnetic disks 10 being magnetic storage media are mounted on the rotary shaft 19 of a spindle motor 18. The spindle motor 18 rotates the magnetic disks 10. An actuator (VCM) 14 includes magnetic heads 12 at its distal end, and it moves the magnetic heads 12 in the radial directions of the magnetic disks 10.

The actuator 14 is configured of a voice coil motor (VCM) which performs revolutions about its rotary shaft. In the illustration, the two magnetic disks 10 are set in the magnetic disk apparatus, and the four magnetic heads 12 are simultaneously driven by the identical actuator 14.

Each of the magnetic heads 12 consists of a read element and a write element. The magnetic head 12 is so configured that the read element including a magnetic resistance (MR) element is stacked on a slider, and that the write element including a write coil is stacked on the read element.

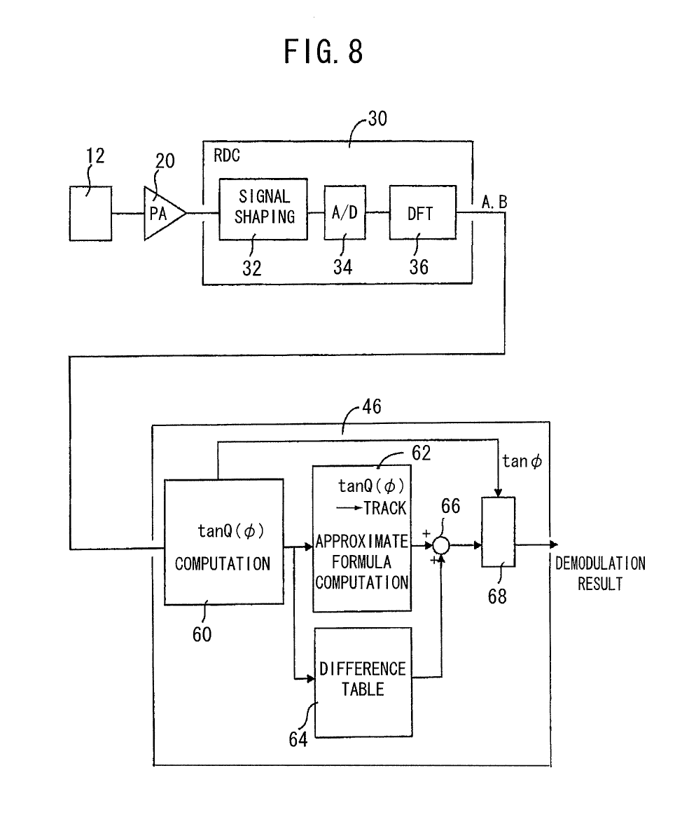

A position signal (analog signal) read by the magnetic head 12 is amplified by a preamplifier 20, and is thereafter inputted to a read channel (servo demodulation circuit) 30. As will be described with reference to FIG. 8, the servo demodulation circuit 30 detects servo marks synchronously, and it demodulates the angles (vector information) of the individual phase patterns of a servo signal.

The demodulated vector information is inputted to a data processing unit (Digital Signal Processor) 40. The data processing unit 40 executes the data processing of a feedback control loop which has a feed-forward (FF) function. A target trajectory generation unit 42 generates the target position trajectory of each sample from a seek start in accordance with a seek distance d, and it generates the target position of each sample from the target position trajectory.

An FF current generation unit 44 generates a feed-forward (FF) current conforming to a velocity curve to the target position, in accordance with the target position trajectory. A present position computation unit 46 computes a present position from the vector information items A and B of the two phase patterns from the servo demodulation circuit 30, as will be described with reference to FIGS. 8, et seq.

A positional error computation unit 48 subtracts the target position from the present position, thereby to compute a positional error (of each sample). A controller 50 computes a feedback current for nullifying the positional error, by an observer control, a PID control, etc. A current addition unit 52 adds up the FF current of the FF current generation unit 44 and the feedback current of the controller 50, thereby to generate a VCM control current. A power amplifier 22 amplifies the VCM control current so as to drive the VCM 14.

That is, the feed-forward current corresponding to the target trajectory is supplied every sample, the error relative to the target trajectory is obtained by the error of the difference between the samples of the target trajectory and the demodulated position, and this error is corrected by the feedback controller 50.

As shown in FIG. 7, the phase servo information SV provided in the sectors of each track of the magnetic disk 10 has the phase region of three phases “even1”, “odd1” and “even2”, and the respective phases are in patterns which have predetermined feed angles per track. More specifically, the phase pattern EVEN1 has a feed angle (per track) of +90 degrees, the phase pattern ODD1 has a feed angle of −90 degrees, and the phase pattern EVEN2 has a feed angle of +90 degrees.

In this example, the ODD1 region is set at a length obtained by adding up the EVEN1 region and the EVEN2 region. Thus, the averaging of read signals becomes possible even in the ODD1 region, and this is effective for eliminating the noise of the vector information B.

(Head Position Demodulating Apparatus)

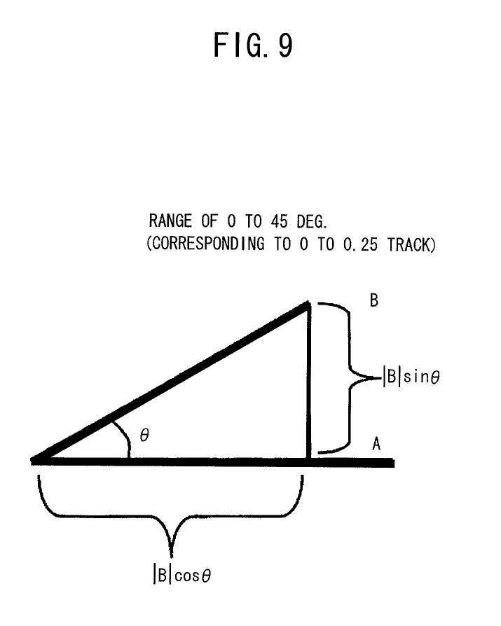

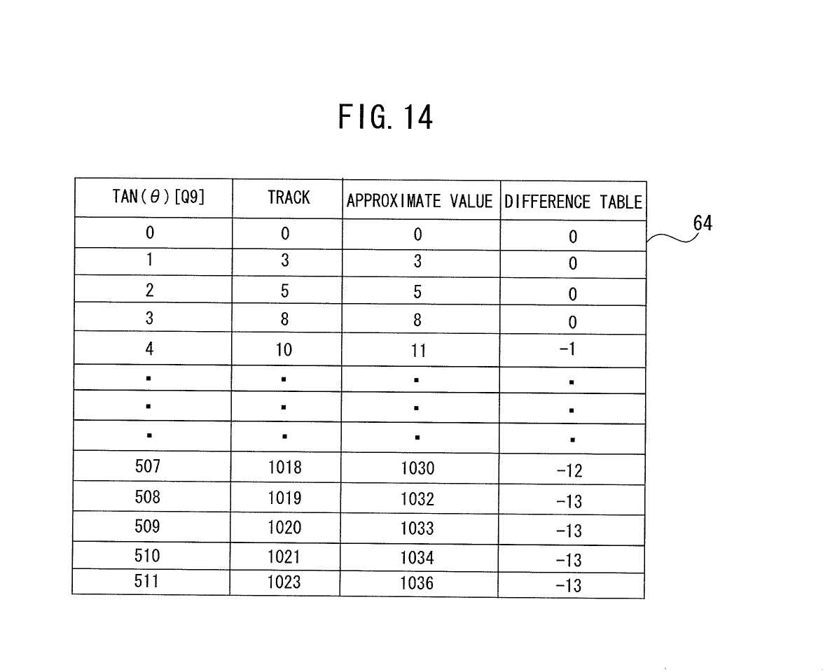

Next, the position demodulating channel in FIG. 6 will be described with reference to FIGS. 8 through 16. FIG. 8 is a block diagram of the position demodulating channel in FIG. 6, FIGS. 9 through 13 are diagrams for explaining a tan(θ) computation unit in FIG. 8, and FIGS. 14 through 16 are diagrams for explaining an approximate formula computation unit in FIG. 8 and a difference table.

As shown in FIG. 8, in the read channel (servo demodulation circuit) 30, the read signal from the preamplifier 20 is inputted to a signal shaping circuit 32. The signal shaping circuit 32 is configured of a high-pass filter (HPF), an AGC circuit, an asymmetric characteristic control circuit (ASC), etc., and it cuts the signal components (for example, DC component) of an unnecessary band, thereby to adjust an amplitude.

The output of the signal shaping circuit 32 is inputted to an analog/digital converter (ADC) 34, and the analog signal is converted into a digital value with a timing-synchronous sample clock. The output of the ADC 34 is Fourier-transformed by a DFT (Digital Fourier Transform) circuit 36. Thus, a temporal function is converted into an angular vector.

In the example of FIG. 7, the ODD1 region, EVEN1 region and EVEN2 region lie at known positions (temporal positions) from the detections of the servo marks, so that the angular vector information A of the EVEN1 and EVEN2 regions and the angular vector information B of the ODD1 region are separated, and they are represented by real numbers and imaginary numbers and outputted.

Next, the present position computation unit 46 will be described. First, as explained by Formulas (3) through (5) mentioned before, the tan (θ) computation unit 60 computes the outer product and inner product of the two vector information items A and B, and it computes the gradient tan(θ) from these products. In this case, calculations to be explained with reference to FIGS. 9 through 13 are further executed in order to reduce a table size.

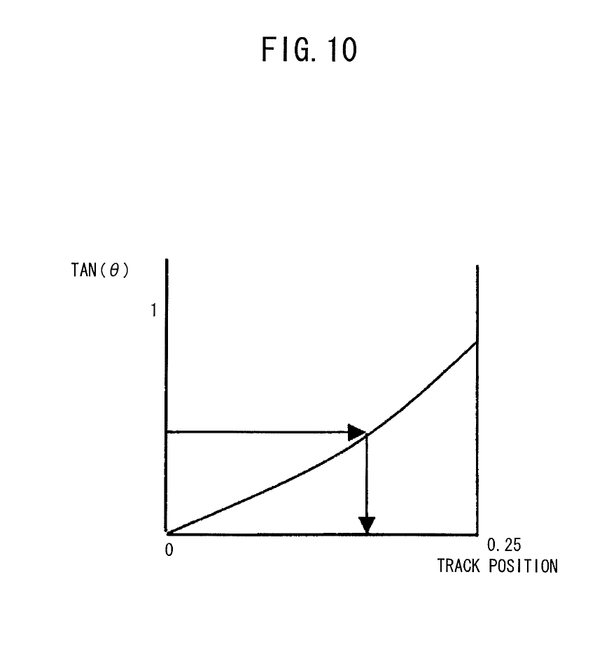

More specifically, the tan(θ) computation unit 60 calculates the outer product with Formula (3) and calculates the inner product with Formula (4). Besides, it compares the value of the outer product and that of the inner product. As shown in FIG. 9, in a case where the value of the outer product is not larger than that of the inner product, the phase difference θ falls within a range of 0 degree through 45 degrees (namely, 0 through 0.25 track), and hence, the value tan(θ) is calculated with Formula (5). As will be stated later, the calculated value tan(θ) is directly converted into a track position as shown in FIG. 10.

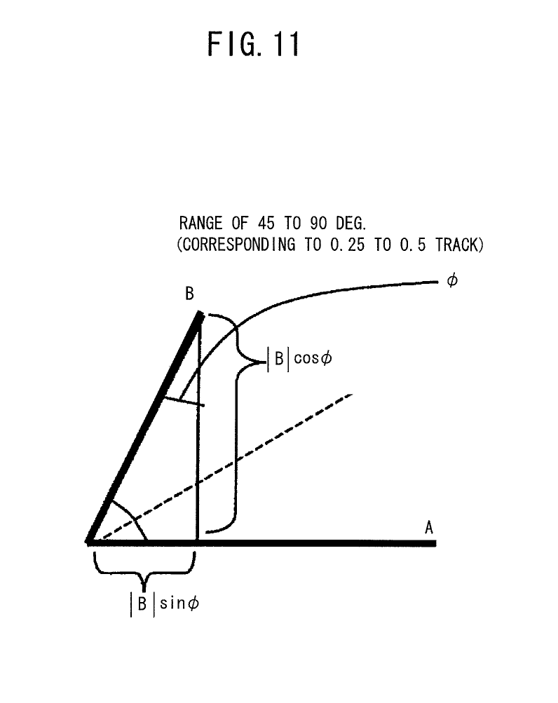

On the other hand, as shown in FIG. 11, in a case where the value of the outer product calculated with Formula (3) is larger than the value of the inner product calculated with Formula (4), the phase difference θ falls within a range of 45 degrees through 90 degrees (namely, 0.25 through 0.5 track), and hence, the tan(θ) computation unit 60 replaces the phase difference θ with (90−φ) in FIG. 11.

The angle φ changes from 45 degrees to 0 degree as the angle θ changes from 45 degrees to 90 degrees. In addition, using the angle φ, an outer product is computed with the following formula (6), an inner product is computed with the following formula (7), and tan φ is calculated with the following formula (8):

$$\begin{matrix}\text{[Formula 6]} & \\ A \times B = \vert A \vert \vert B \vert cos θ outer product & ( 6 ) \\ \text{[Formula 7]} & \\ A \cdot B = \vert A \vert \vert B \vert sin θ inner product & ( 7 ) \\ \text{[Formula 8]} & \\ tan φ = \frac{\vert A \vert \vert B \vert sin φ}{\vert A \vert \vert B \vert cos φ} = \frac{A \cdot {B}^{( inner product )}}{A \times {B}^{( outer product )}} & ( 8 )\end{matrix}$$

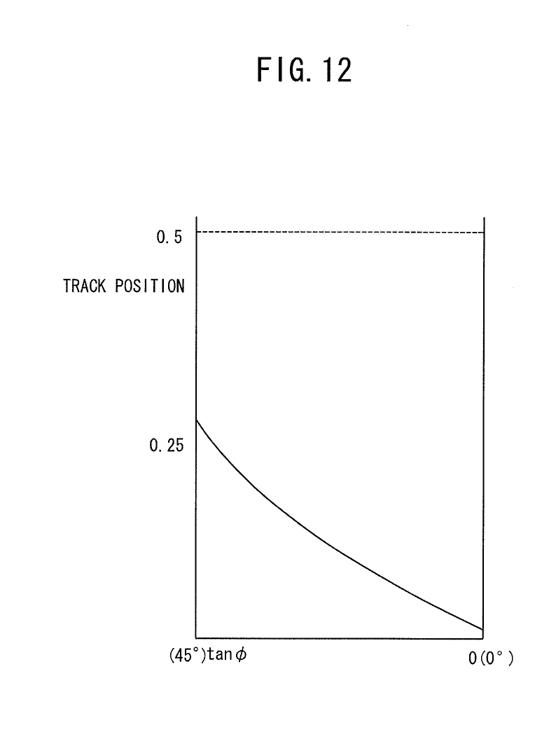

As will be stated later, the calculated value tan φ is directly converted into a track position as shown in FIG. 12. In addition, a position offset magnitude obtained from the value tan φ is subtracted from an offset corresponding to 0.5 track, thereby to obtain a correct track position.

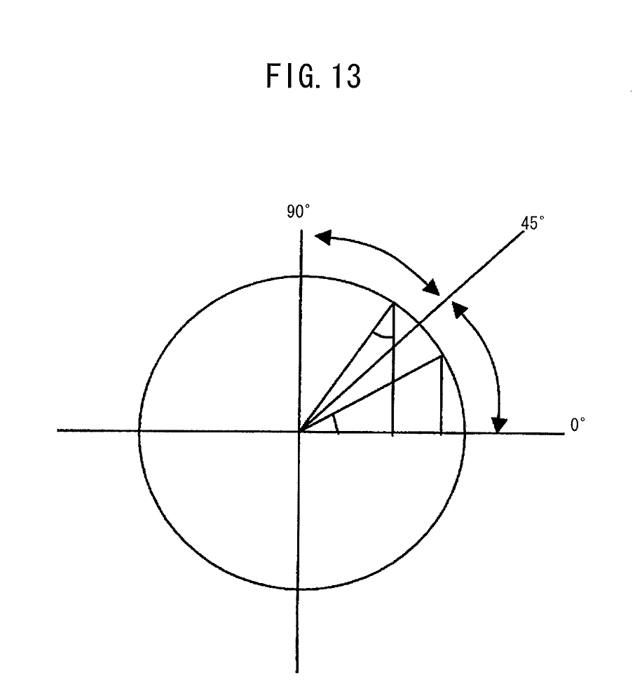

More specifically, as shown in FIG. 13, the phase difference of 0 degree through 45 degrees is computed with θ, and the phase difference of 45 degrees through 90 degrees is computed with φ(=90−θ). Thus, as will be stated later, track positions of 0 degree through 90 degrees (a position offset magnitude from the center of the track) are obtained from a table for 0 degree through 45 degrees.

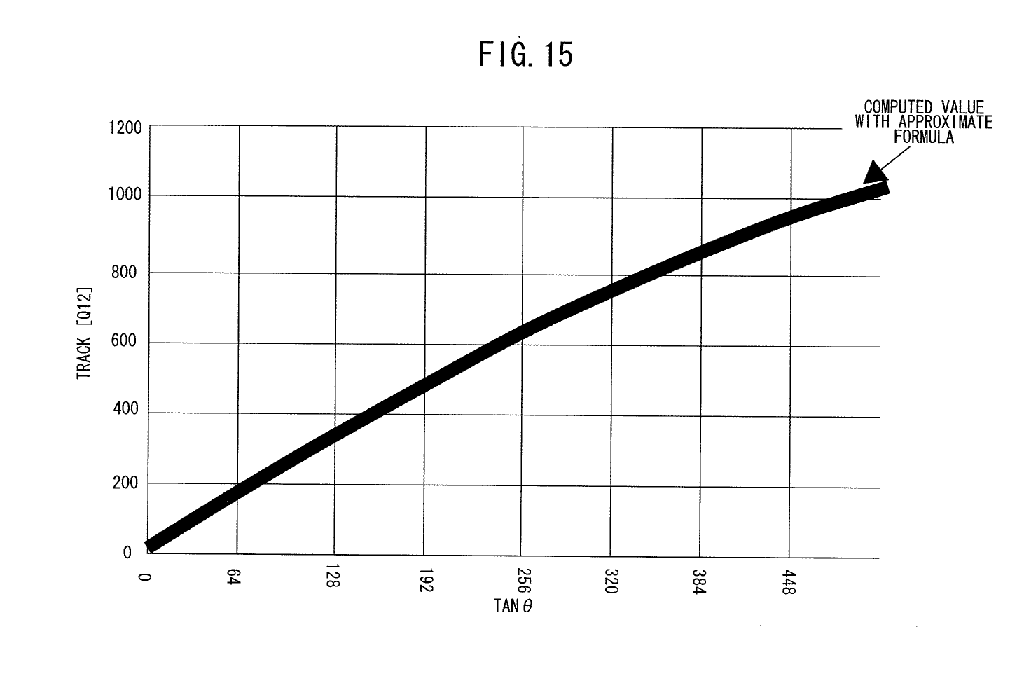

Referring back to FIG. 8, the computed value tan(θ) is converted into the track position in terms of the difference from the value of an approximate formula. More specifically, an approximate formula computation unit 62 and a difference table 64 are disposed. First, as shown in FIG. 15, the approximate formula computation unit 62 approximates the value tan (θ) to the track position in conformity with the approximate formula of low degree. As the low-degree approximate formula for the ATAN calculation and the track position conversion, the following formula (9) is employed:

### [Formula 9]

g(x)=−0.0D14x²+2.71285x (9)

This approximate formula is basically a quadratic function, and it does not consume a considerable computing time period.

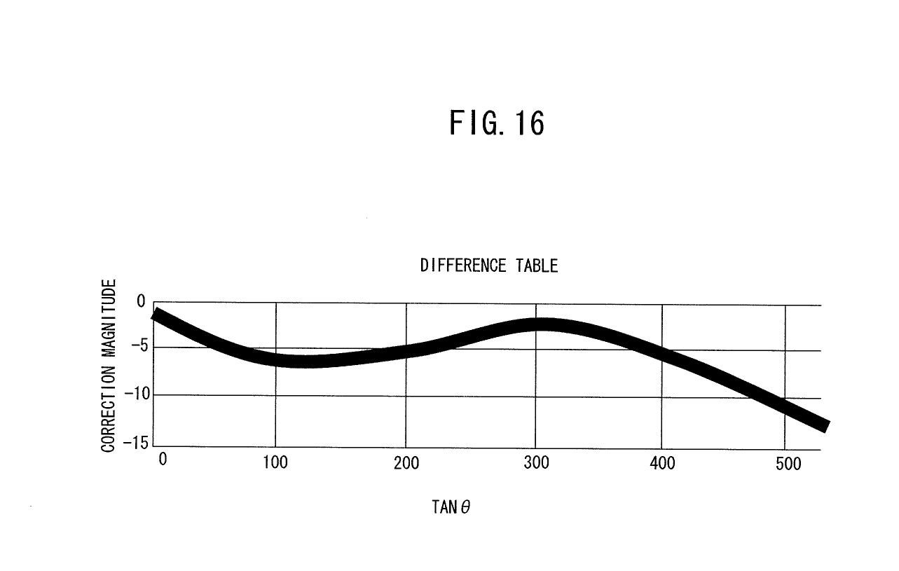

On the other hand, in the difference table 64, the difference between the correct track position and the track position computed with the approximate formula is stored for each tan(θ) value. FIG. 16 shows those differences (correction magnitudes) of the difference table 64 which are stored in correspondence with the values tan(θ).

In addition, the computed value tan(θ) is inputted to the approximate formula computation unit 62, the approximate formula is calculated as shown in FIG. 15, and the approximate track position is obtained. Besides, the difference table 64 is referred to on the basis of the value tan(θ), so as to obtain a corresponding difference value. Further, an addition unit 66 adds up the approximated track position and the difference value, so as to output the correct track position.

FIG. 14 is the diagram for explaining the difference table 64. Here, the gradient tan(θ) is set at a resolution of 512 steps (a range of 0 through 0.25 track), and the correct track positions corresponding to the values of the steps are listed by the sides thereof. In addition, approximate values are the track positions computed with the approximate formula mentioned before. Accordingly, the difference table 64 stores therein the differences (correct track positions−approximate values) corresponding to the individual values tan(θ).

In a case where the correct track positions are stored in a table, the size of the table becomes (12 bits×512 stages) In contrast, when the differences are stored in the table as described above, the size of the table becomes (4 bits×512 stages) and suffices with about ⅓.

Moreover, since the approximate formula employed is of low degree, a processing load is light, and a computing speed can be prevented from lowering.

Besides, in the case where the variable tan φ explained with reference to FIGS. 11 and 12 has been computed, the value tan φ is similarly inputted to the approximate formula computation unit 62, and an approximate formula is calculated as shown in FIG. 15, so as to obtain an approximated track position offset. Besides, a difference table 64 is referred to on the basis of the value tan φ, so as to obtain a corresponding difference value. Further, the addition unit 66 adds up the approximated track position and the difference value, thereby to compute a track position offset magnitude. Subsequently, a subtraction block 68 subtracts the added track position offset magnitude from the value corresponding to 0.5 track. Thus, a correct track position offset value can be demodulated. In this manner, the approximate formula computation and the reference to the table can be performed as in the case of the variable tan θ.

More specifically, the angle φ changes from 45 degrees to 0 degree as the angle θ changes from 45 degrees to 90 degrees (from 0.25 track to 0.5 track in terms of the track position) Accordingly, a position offset magnitude for 0.25 track to 0.5 track is outputted in correspondence with the value of the angle φ. Therefore, as described with reference to FIG. 12, the addition value between the approximate formula and the difference as obtained with the value tan φ is subtracted from the 0.5 track, whereby the correct track position offset magnitude is obtained by computing the approximate formula and referring to the table as in the case of the variable tan θ.

In this manner, the approximate formula and the difference table have been used for computing the position offset magnitude relative to the track center from the tan value of the phase servo demodulation. Therefore, the table size can be sharply reduced, and the position demodulation can be performed at a high precision even with a processor of low speed. Accordingly, position demodulation with high precision can be realized for a low price.

### 2. Second Embodiment

In the foregoing embodiment, the position demodulation has been exemplified as the head position demodulation of the magnetic disk apparatus, but the present technique is also applicable to another disk apparatus such as optical disk apparatus. Besides, the example in which the computing method is altered with the boundary at the phase difference of 45 degrees has been described before, but the technique is also applicable to a case where such an operation is not performed.

Although the preferred embodiments have been described above, the technique can be variously modified within the scope of the purport thereof, and the modifications shall not be excluded from the scope of the technique.

In accordance with the technique, in order to demodulate a phase servo pattern, an approximate formula and a difference table are used for computing a position offset magnitude relative to the center of a track from a computed tangent value. Therefore, a table size can be sharply reduced, and a position demodulation becomes possible at a high precision even with a processor of low speed. Accordingly, the position demodulation of the high precision can be realized by an apparatus of low price.

What is claimed is:

1. A storage apparatus which includes, at least, a head for reading data of a plurality of tracks arranged on a storage medium, and in which a servo pattern read by the head is demodulated so as to detect a position of the head, comprising:
a phase servo pattern region in which a plurality of phase patterns having phases differing between respectively adjacent ones of the plurality of tracks have phases opposite to each other;
a servo demodulation circuit which demodulates first vector information of a first phase pattern of the plurality of phase patterns and second vector information of a second phase pattern opposite in phase to the first phase pattern, from a signal of the phase servo pattern region as reproduced by the head; and
a control unit which detects a position offset magnitude of the head from a center of the track, on the basis of an angular difference between the first vector information and the second vector information, and which drives an actuator for a head in accordance with the detected position offset magnitude, so as to locate the head on the center of the target track;
wherein the control unit includes a processing unit which calculates an outer product and an inner product of the first and second vector information items, which calculates a tangent value of the angular difference by a division between a value of the outer product and a value of the inner product, and which converts the tangent value into track position information in conformity with an approximate formula, and a difference table in which each difference between the track position information corresponding to the tangent value and a value of the approximate formula is stored, and wherein the processing unit adds up the track position information based on the approximate formula and the difference, thereby to demodulate the position offset magnitude.

2. The storage apparatus according to claim 1, wherein the processing unit computes a nonlinear function as the approximate formula.

3. The storage apparatus according to claim 2, wherein the processing unit computes a quadratic approximate formula as the approximate formula.

4. The storage apparatus according to claim 1, wherein the processing unit demodulates a position offset magnitude within a range from the track center to 0.5 track, as the position offset magnitude.

5. The storage apparatus according to claim 1, wherein the processing unit executes a servo calculation for locating the head on the target track center in accordance with the demodulated position offset magnitude.

6. The storage apparatus according to claim 1, wherein the servo demodulation circuit demodulates that first vector information of the first phase pattern whose feed angle between the tracks of the storage medium is +90 degrees, and that second vector information of the second phase pattern whose feed angle between the tracks is −90 degrees.

7. The storage apparatus according to claim 1, wherein the servo demodulation circuit includes a Fourier transform circuit which subjects the reproduced signal of the head to a Fourier transform, thereby to demodulate the first vector information and the second vector information.

8. The storage apparatus according to claim 1, wherein in a case where the processing unit has decided that the outer product value is larger than the inner product value, by comparing the outer product value and the inner product value, it divides the inner product value by the outer product value, so as to calculate a first tangent value of the angular difference, and in a case where the processing unit has decided that the outer product value is not larger than the inner product value, it divides the outer product value by the inner product value, so as to calculate a second tangent value of the angular difference.

9. The storage apparatus according to claim 8, wherein in the case where the processing unit has calculated the first tangent value, it converts the first tangent value into the track position information in conformity with the approximate formula, and it refers to the difference table with the first tangent value, thereby to obtain the difference, while in the case where the processing unit has calculated the second tangent value, it converts the second tangent value into the track position information in conformity with the approximate formula, and it refers to the difference table with the second tangent value, thereby to obtain the difference, and the processing unit subjects the track position information and the difference to a correction computation with a predetermined track position offset magnitude, thereby to demodulate the position offset magnitude.

10. A head position demodulating apparatus in which a position offset magnitude is demodulated from a phase servo pattern recorded on a track of a storage medium, comprising:
a processing unit which receives first vector information of a first phase pattern of the phase servo pattern and second vector information of a second phase pattern opposite in phase to the first phase pattern, which calculates an outer product and an inner product of the first and second vector information items, which calculates a tangent value of an angular difference between the first and second vector information items, by a division between a value of the outer product and a value of the inner product, and which converts the tangent value into track position information in conformity with an approximate formula; and
a difference table in which each difference between the track position information corresponding to the tangent value and a value of the approximate formula is stored;
wherein the processing unit adds up the track position information based on the approximate formula and the difference, thereby to demodulate the position offset magnitude.

11. The head position demodulating apparatus according to claim 10, wherein the processing unit computes an approximate formula of nonlinear function as the approximate formula.

12. The head position demodulating apparatus according to claim 11, wherein the processing unit computes a quadratic approximate formula as the approximate formula.

13. The head position demodulating apparatus according to claim 10, wherein the processing unit demodulates a position offset magnitude within a range from a center of the track to 0.5 track, as the position offset magnitude.

14. The head position demodulating apparatus according to claim 10, wherein the processing unit executes a servo calculation for locating a head on the target track center in accordance with the demodulated position offset magnitude.

15. The head position demodulating apparatus according to claim 10, further comprising a servo demodulation circuit which demodulates the first vector information and the second vector information from a reproduced signal of a head for the phase servo pattern.

16. The head position demodulating apparatus according to claim 15, wherein the servo demodulation circuit demodulates that first vector information of the first phase pattern whose feed angle between the tracks of the storage medium is +90 degrees, and that second vector information of the second phase pattern whose feed angle between the tracks is −90 degrees.

17. The head position demodulating apparatus according to claim 15, wherein the servo demodulation circuit includes a Fourier transform circuit which subjects the reproduced signal of the head to a Fourier transform, thereby to demodulate the first vector information and the second vector information.

18. The head position demodulating apparatus according to claim 10, wherein in a case where the processing unit has decided that the outer product value is larger than the inner product value, by comparing the outer product value and the inner product value, it divides the inner product value by the outer product value, so as to calculate a first tangent value of an angular difference between the first and second vector information items, and in a case where the processing unit has decided that the outer product value is not larger than the inner product value, it divides the outer product value by the inner product value, so as to calculate a second tangent value of the angular difference.

19. The head position demodulating apparatus according to claim 18, wherein in the case where the processing unit has calculated the first tangent value, it converts the first tangent value into the track position information in conformity with the approximate formula, and it refers to the difference table with the first tangent value, thereby to obtain the difference, while in the case where the processing unit has calculated the second tangent value, it converts the second tangent value into the track position information in conformity with the approximate formula, and it refers to the difference table with the second tangent value, thereby to obtain the difference, and the processing unit subjects the track position information and the difference to a correction computation with a predetermined track position offset magnitude, thereby to demodulate the position offset magnitude.
